(19) United States
(12) Patent Application Publication
(10) Pub. No.: US 2017/0005509 A1
(43) Pub. Date: Jan. 5, 2017

(54) BATTERY CHARGER

(71) Applicant: Asmo SALORANTA, Oulu (FI)

(72) Inventor: Asmo SALORANTA, Oulu (FI)

(21) Appl. No.: 15/114,229

(22) PCT Filed: Jan. 23, 2015
(86) PCT No.: PCT/EP2015/051370

§ 371 Date: Jul. 26, 2016

(30) Foreign Application Priority Data
Jan. 27, 2014 (FI) 20140021

(51) Int. Cl. H02J 9/00; H02J 7/00

(52) U.S. Cl. CPC H02J 9/005; H02J 7/0052; H02J 2007/0062

(57) ABSTRACT

A battery charger including an electronic circuit configured to control the battery charger such that if an electrical input connector is connected to mains electricity, and an electrical output connector becomes connected with a device to be charged, the electronic circuit is configured to sense wake-up current coming from the device to be charged and an on/off-switch is controlled on such that a transformer is connected to the mains electricity, whereby the battery charger starts to charge the device to be charged.

### FIELD

The invention relates to a battery charger.

### BACKGROUND

Existing battery chargers consume electricity when plugged into an AC mains network but not connected to a rechargeable device. Such a charger should always be unplugged from the mains electricity when not in use, in order to save electricity and minimize the risk of fire. The continuous consumption of electricity by traditional chargers connected to an AC network causes both electricity wastage and the risk of fire as compared to an unplugged charger. The drawback of a traditional charger is that a user must unplug it after use so as not to consume electricity unnecessarily.

### BRIEF DESCRIPTION

The present invention seeks to provide an improved battery charger.

According to an aspect of the present invention, there is provided a battery charger as specified in claim 1.

The battery charger of the invention consumes no electric power when a device to be charged is not connected, even if the battery charger itself is connected to the mains electricity. This saves electricity and removes the risk of the battery charger catching fire due to short-circuit or other malfunction.

### LIST OF DRAWINGS

Example embodiments of the present invention are described below, by way of example only, with reference to the accompanying drawings, in which

FIG. 1 illustrates example embodiments of a battery charger;

FIG. 2 is a flowchart illustrating example embodiments of the operation of the battery charger;

FIG. 3 is a circuit diagram illustrating an example embodiment of wirings of the battery charger;

FIG. 4 illustrates an example embodiment of the battery charger as a power source for a laptop computer; and

FIG. 5 illustrates an example embodiment of the battery charger as a power source for a mobile phone.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

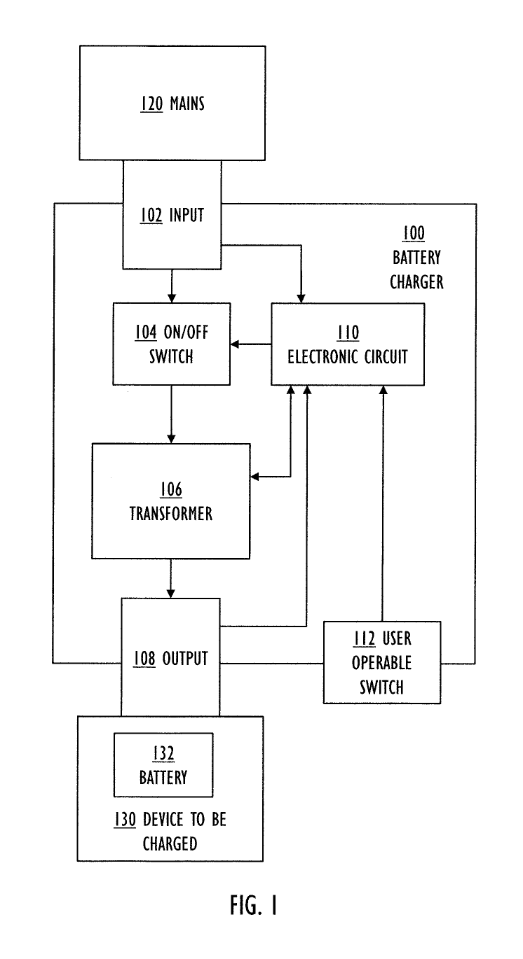

FIG. 1 illustrates example embodiments of a battery charger 100.

The battery charger 100 comprises an electrical input connector 102 coupleable with mains electricity 120, and an electrical output connector 108 coupleable with a device 130 to be charged.

The battery charger 100 also comprises a transformer 106 transforming the mains electricity power from the electrical input connector 102 to lower voltage power for the electrical output connector 108, and an on/off-switch 104 between the electrical input connector 102 and the transformer 106.

Furthermore, the battery charger 100 comprises an electronic circuit 110 configured to control the battery charger 100.

The electronic circuit 110 is configured to control the battery charger 100 such that if the electrical input connector 102 is connected to the mains electricity 120, and the electrical output connector 108 becomes connected with the device 130 to be charged, the electronic circuit 110 is configured to sense wake-up current coming from the device 130 to be charged and the on/off-switch 104 is controlled on such that the transformer 106 is connected to the mains electricity 120, whereby the battery charger 100 starts to charge the device 130 to be charged.

In an example embodiment, the electronic circuit 110 is configured to control the battery charger 100 such that if the electrical input connector 102 is connected to the mains electricity 120, but the electrical output connector 108 remains disconnected from the device 130 to be charged, the on/off-switch 104 is controlled off such that the transformer 106 is disconnected from the mains electricity 120, whereby the battery charger 100 does not consume the mains electricity power.

In an example embodiment, the electronic circuit 110 is configured to control the battery charger 100 such that if the electrical input connector 102 is connected to the mains electricity 120, and the electrical output connector 108 is connected with the device 130 to be charged, the electronic circuit 130 is configured to sense when the device 100 to be charged is fully charged, whereupon the on/off-switch 104 is controlled off such that the transformer 106 is disconnected from the mains electricity 120, whereby the battery charger 100 stops to consume the mains electricity power.

In an example embodiment, the electronic circuit 110 is configured to control the battery charger 100 such that if the electrical input connector 102 remains connected to the mains electricity 120, but the electrical output connector 108 becomes disconnected from the device 100 to be charged, the on/off-switch 104 is controlled off such that the transformer 106 is disconnected from the mains electricity 120, whereby the battery charger 100 stops to consume the mains electricity power.

In an example embodiment, the battery charger 100 further comprises a user-operable switch 112, which, when operated, controls the on/off-switch 104 on such that the transformer 106 is connected to the mains electricity 120, whereby the battery charger 100 starts to charge the device 130 to be charged even if a battery 132 of the device 130 to be charged is empty, which prevents the device 130 to be charged to provide the wake up current.

In an example embodiment, the user-operable switch 112 is in the electrical output connector 108 or adjacent to the electrical output connector 108.

In an example embodiment, the device 130 to be charged operates according to the USB OTG (Universal Serial Bus On-The-Go)-standard. The USB OTG allows a USB device (a mobile phone, for example) to act as a host, which allows another USB device (a USB flash drive, for example) to be coupled with it.

In an example embodiment, the device 130 to be charged, after being connected to the electrical output connector 108, provides the wake-up current in a host state. In an example embodiment, the device 100 to be charged changes from the host state to a device state after a predetermined delay, whereupon the battery charger 100 starts to charge the device 130 to be charged. These two example embodiment utilize the feature of USB OTG allowing the device 130 to be charged to drop the hosting role and act as normal USB device when attached to another host (=the battery charger 100).

In an example embodiment, the battery charger 100 switches itself on automatically only when connected to a source of mains AC current and an USB OTG-compatible rechargeable device 130.

In an example embodiment, when the battery charger 100 is connected to a mains AC power source and a connected rechargeable device 130 is disconnected from the battery charger 100, the battery charger turns itself off automatically by means of an electronic circuit 110 such as a relay or another component.

The battery charger 100 receives the power it needs to turn itself on from the battery of a rechargeable device supporting a ‘USB OTG’ connector. The automatic start-up feature of the battery charger 100 works with devices 130 supporting USB OTG. Nonetheless, the battery charger 100 may be used to charge non USB OTG-compliant devices 130 in the following manner.

When connected to AC mains current 120 and to a device 130 not supporting USB OTG, the battery charger 100 will not start up automatically. In such cases, the battery charger 100 may be turned on by pressing a button 112 in its casing, causing the relay or another component in the charger 100 to connect to the AC current 120. The button 112 on the battery charger 100 is also intended for use in situations in which the battery 132 of a rechargeable device 130 connected to the battery charger 100 is completely empty, or a rechargeable device 130 connected to the battery charger 100 has been switched off.

Please note that the battery charger 100 turns itself off automatically when a rechargeable device 130 is disconnected from the battery charger 100, irrespective of whether that rechargeable device 130 supports or does not support USB OTG.

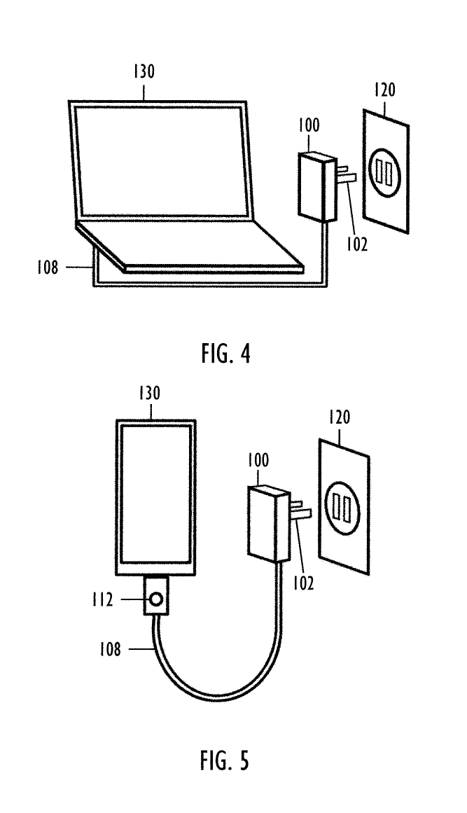

As FIGS. 4 and 5 illustrate, the battery charger 100 is suitable for charging portable devices, for example, such as mobile telephones, tablets, laptops and notebook computers.

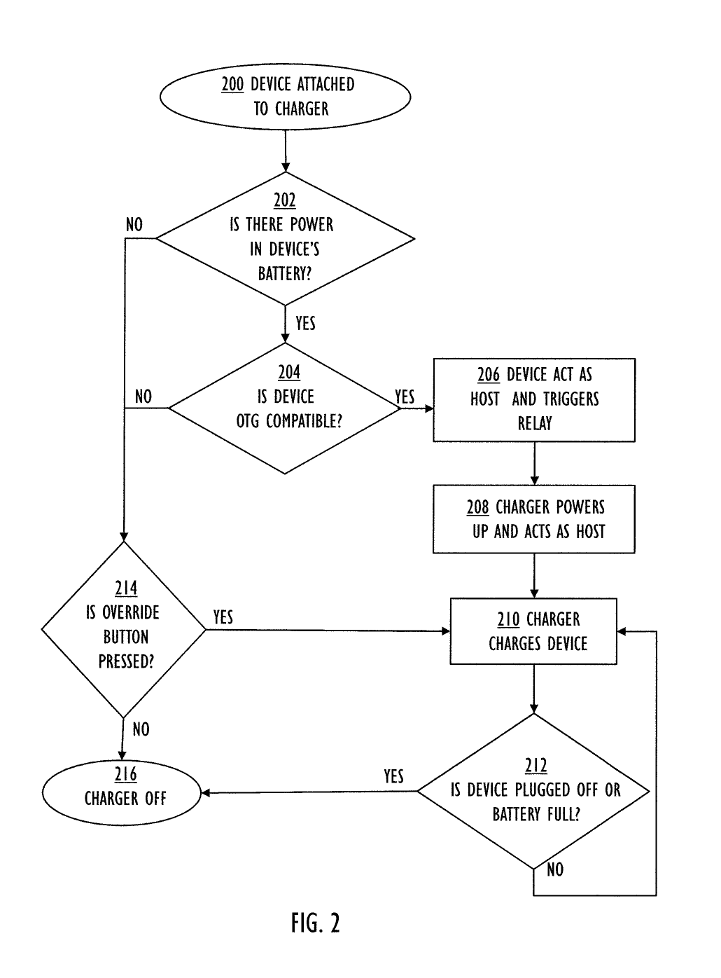

FIG. 2 illustrates example embodiments of the operation of the battery charger 100.

A rechargeable device is connected 200 to the battery charger.

If the battery of the rechargeable device contains a charge 202 YES, the rechargeable device is switched on, and if the rechargeable device is OTG-compatible 204, the rechargeable device acts 206 as a host, feeding a wake-up current to the charger. The charger connects 208 to the AC power source and is recognized by the rechargeable device as a charger and the rechargeable device enters a device state. The charger charges 210 the connected device, until the rechargeable device is disconnected 212 from the charger, whereupon, the charger turns 216 off.

If the battery of a rechargeable device is empty 202 NO, the connected device is in an ‘off’ state, or the device is not USB OTG compatible 204 NO, the battery charger will not switch on until the user presses 214 the button on the charger 214, which starts the charger and the charger begins 210 to charge the rechargeable device. The charger charges 210 the connected device, until the connected device is disconnected 212 from the charger, or the battery is full, whereupon the charger turns 216 off.

The operation of the charger may be based on the use of both the host and device modes of the USB OTG specification. In host mode, the connected rechargeable device is required to feed voltage to the USB connector and to wake up the charger. After this wake up, normal charging will commence.

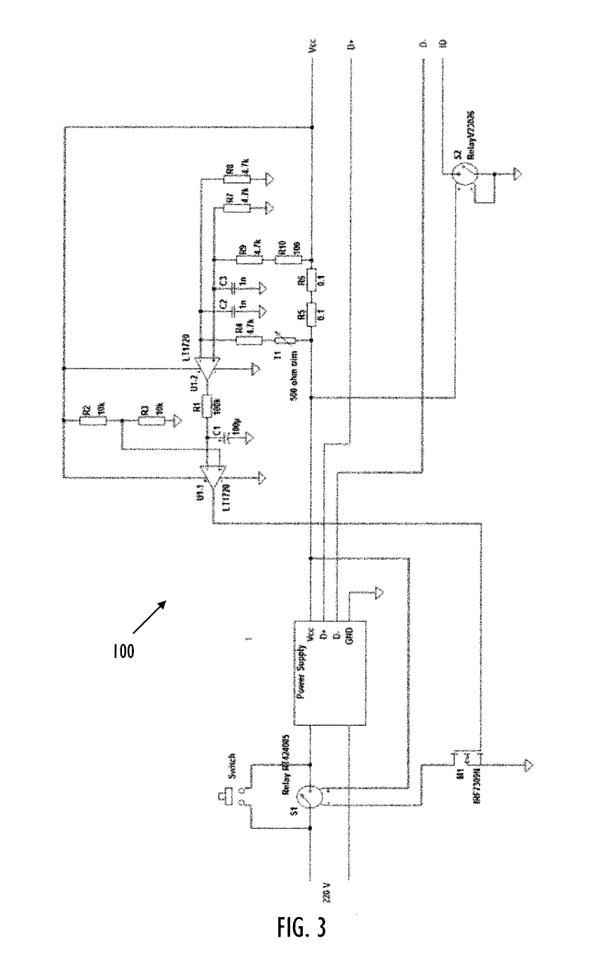

FIG. 3 is a circuit diagram illustrating an example embodiment of wirings of the battery charger 100.

Initially, the charger 100 is disconnected from the mains current 120 with a relay. When a phone or another USB OTG compatible device 130 is connected, the charger 100 will appear to be of a USB OTG device type. This will cause the phone 130 to feed a voltage to the USB Vcc line, closing the relay and starting the charger 100. The charger 100 will then change itself to appear as a host-type charger, causing the USB OTG compatible rechargeable device 130 to detect it and normal charging to start.

In the initial state, the mains relay S1 is open, and no power is fed to the circuitry. Relay S2 is holding the ID line shorted to ground. Note that S2 is CLOSED when not energized. When an USB OTG compatible device 130 is connected, the grounded ID pin will make the charger 100 appear as a slave-type device requiring a supply voltage. The attached device will then supply 5 V to the Vcc line. The following will occur:

1. The connected voltage will energize double comparator circuitry U1, and as capacitor C1 is empty, the inputs to U1-1 will cause the output to go HIGH. This will open MOSFET M1, causing the relay S1 to energize and mains power to be fed to the power supply. It will then start feeding 5 V to the charger circuitry.

2. Relay S2 will also be energized, disconnecting the ID pin, which will cause the connected device 130 to believe that the slave-type device was disconnected. The connected device 130 then detects the D+ and D− pins as shorted inside the power supply, meaning that a high power charger 100 has been connected and that charging will start.

Initially, when the charger 100 starts up, U1-2 will have an output of LOW and will begin charging capacitors C1 through R1. The rate is set by the value of C1 and R1 and is set to be in an order of seconds to allow for the delay in the start of charging. When the connected device 130 does begin the charging, the voltage drop across resistors R5 and R6 will cause the comparator U1-2 output to go LOW, keeping C1 empty and comparator U1-1 output HIGH.

When the connected device 130 is disconnected, current through resistors R5 and R6 drops to nearly zero. This will switch comparator U1-2 output to HIGH, and after the delay set by R1 and C1, comparator U1-1 output will go LOW, closing MOSFET M1 and relay S1, and the charger 100 will be disconnected.

Capacitors C2 and C3 are filtering high frequency noise from the comparator inputs. Resistors R2 and R3 set the trigger voltage to U1-1. Resistors R4, R7, R8, R9 and R10 are used to set the compared voltages to a comparator allowable range and close enough to detect changes in charging current.

Trimmer T1 is used to fine-tune comparator inputs so that in a no-charge state, meaning no current flows through R5 and R6, comparator U1-2 negative input is slightly lower than positive input, keeping the output HIGH. When charging, the voltage drop across R5 and R6 causes the negative input of U1-2 to be higher than the positive input, keeping the output LOW.

If the battery 132 of the connected device 130 is empty or the connected device 130 is USB OTG incompatible, it cannot feed the starting voltage to the charger 100. In this case, a momentary press of the push button switch 112 is enough to energize the charger 100 and start the sequence.

It will be obvious to a person skilled in the art that, as technology advances, the inventive concept can be implemented in various ways. The invention and its embodiments are not limited to the example embodiments described above but may vary within the scope of the claims.

1-9. (canceled)

10. A battery charger comprising:
an electrical input connector coupleable with mains electricity;
an electrical output connector coupleable with a device to be charged;
a transformer transforming the mains electricity power from the electrical input connector to lower voltage power for the electrical output connector;
an on/off-switch between the electrical input connector and the transformer; and
an electronic circuit configured to control the battery charger;
wherein the electronic circuit is configured to control the battery charger such that if the electrical input connector is connected to the mains electricity, and the electrical output connector becomes connected with the device to be charged, the electronic circuit is configured to sense wake-up current coming from the device to be charged and the on/off-switch is controlled on such that the transformer is connected to the mains electricity, whereby the battery charger starts to charge the device to be charged.

11. The battery charger of claim 10, wherein the electronic circuit is configured to control the battery charger such that if the electrical input connector is connected to the mains electricity, but the electrical output connector remains disconnected from the device to be charged, the on/off-switch is controlled off such that the transformer is disconnected from the mains electricity, whereby the battery charger does not consume the mains electricity power.

12. The battery charger of claim 10, wherein the electronic circuit is configured to control the battery charger such that if the electrical input connector is connected to the mains electricity, and the electrical output connector is connected with the device to be charged, the electronic circuit is configured to sense when the device to be charged is fully charged, whereupon the on/off-switch is controlled off such that the transformer is disconnected from the mains electricity, whereby the battery charger stops to consume the mains electricity power.

13. The battery charger of claim 10, wherein the electronic circuit is configured to control the battery charger such that if the electrical input connector remains connected to the mains electricity, but the electrical output connector becomes disconnected from the device to be charged, the on/off-switch is controlled off such that the transformer is disconnected from the mains electricity, whereby the battery charger stops to consume the mains electricity power.

14. The battery charger of claim 10, further comprising a user-operable switch, which, when operated, controls the on/off-switch on such that the transformer is connected to the mains electricity, whereby the battery charger starts to charge the device to be charged even if a battery of the device to be charged is empty, which prevents the device to be charged to provide the wake up current.

15. The battery charger of claim 14, wherein the user-operable switch is in the electrical output connector or adjacent to the electrical output connector.

16. The battery charger of claim 10, wherein the device to be charged operates according to the USB OTG-standard.

17. The battery charger of claim 16, wherein the device to be charged, after being connected to the electrical output connector, provides the wake-up current in a host state.

18. The battery charger of claim 17, wherein the device to be charged changes from the host state to a device state after a predetermined delay, whereupon the battery charger starts to charge the device to be charged.
